(19) United States
(12) Patent Application Publication
(10) Pub. No.: US 2017/0083297 A1
(43) Pub. Date: Mar. 23, 2017

(54) ONLINE DISCUSSING SYSTEM WITH COMPILING PROGRAM FUNCTION AND METHOD THEREOF

(71) Applicant: INSTITUTE FOR INFORMATION INDUSTRY, TAIPEI (TW)

(72) Inventors: Cheng-Chih CHIANG, New Taipei City (TW); Hsiao-Chien TSENG, Yilan County (TW); Chieh-Feng CHIANG, Taoyuan City (TW)

(21) Appl. No.: 14/920,897

(22) Filed: Oct. 23, 2015

(30) Foreign Application Priority Data
Sep. 17, 2015 (TW) 104130805

(51) Int. Cl. G06F 9/45; G06Q 50/00

(52) U.S. Cl. CPC G06F 8/41; G06Q 50/01

(57) ABSTRACT

An online discussing method includes following steps: receiving and verifying a user information from an electronic device by a server, and transmitting an online discussing interface to the electronic device after verifying the user information; receiving a programming language selection signal inputted from the programming language selection interface; providing a programming language selection interface to the electronic device; selectively receiving a reply program received from the online discussing interface; wherein, when the server receives the reply program, the server determines interpreting or compiling the reply program according to the programming language selection signal; executing the reply program and outputting an execution result; and recording the reply program and the execution result, and displaying the reply program and the execution result on the online discussing interface.

### RELATED APPLICATIONS

This application claims priority to Taiwan Application Serial Number 104130805, filed Sep. 17, 2015, the entirety of which is herein incorporated by reference.

### BACKGROUND

Field

The present disclosure relates to an online discussing system with compiling program function and method thereof. More particularly, the present disclosure relates to an online discussing system with compiling or interpreting program function and method thereof that can be applied after selecting a program language.

Description of Related Art

With the spread of the online discussing system, every one can post the articles of different subjects. The main purpose of the conventional online discussing system is to post a message, such as raising question, answering question, or providing a comment by users. This makes that the online discussing system provides a discussing platform for exchanging messages to users.

However, the conventional online discussing system only can be used for posting articles, replying questions, raising problems, and providing comments by inputting words. The conventional online discussing system cannot provide the other functions. It is hard for a questioner to clearly present the problem by words when the questioner wants to raise a discussion related to the programming problem. Also, it is hard for a replier to immediately realize the question and succinctly provide a correct solution described only by words. Therefore, how to detect the programming problem easily becomes a problem to be solved in art.

### SUMMARY

One aspect of the present disclosure is related to an online discussing system. In accordance with one embodiment of the present disclosure, the online discussing system includes: a server. The server includes: a storage device, a first processor, an authentication module, an interpreting or compiling module, a result determining module, and an interactive recording module. The first processor is coupled to the storage device and configured to execute the plurality of modules including the authentication module, the interpreting or compiling module, the result determining module and an interactive recording module; wherein the authentication module receives and verifies a user information from an electronic device; after verifying the user information, the authentication module transmits a programming language selection interface and an online discussing interface to the electronic device. The interpreting or compiling module receives a programming language selection signal inputted from the programming language selection interface, and selectively receives a reply program received from the online discussing interface; wherein, when the interpreting or compiling module receives the reply program, the interpreting or compiling module determines interpreting or compiling the reply program according to the programming language selection signal. The result determining module executes the reply program and outputting an execution result to the interpreting or compiling module. The interactive recording module records the reply program and the execution result, and displaying the reply program and the execution result on the online discussing interface.

Another aspect of the present disclosure is related to a method. The method includes: receiving and verifying a user information from an electronic device by a server, and transmitting an online discussing interface to the electronic device after verifying the user information; receiving a programming language selection signal inputted from the programming language selection interface; providing a programming language selection interface to the electronic device; selectively receiving a reply program received from the online discussing interface; wherein, when the server receives the reply program, the server determines interpreting or compiling the reply program according to the programming language selection signal; executing the reply program and outputting an execution result; and recording the reply program and the execution result, and displaying the reply program and the execution result on the online discussing interface.

These and other features, aspects, and advantages of the present disclosure will become better understood with reference to the following description and appended claims. Through utilizing one embodiment described above, the disclosure provides the programmer a discussing platform. And, the programs can be online compiled or interpreted to detect the problems. The online discussing system solves the problem of the inconsistent programming environments between the replier and the questioner. The disclosure overcomes the limitation of installation environments corresponded to the different programming languages.

### BRIEF DESCRIPTION OF THE DRAWINGS

The disclosure can be more fully understood by reading the following detailed description of the embodiment, with reference made to the accompanying drawings as follows:

FIG. 1 is a block diagram of an online discussing system with compiling program function according to one embodiment of the present disclosure.

FIG. 2 is a schematic of a programming language selection interface according to one embodiment of the present disclosure.

FIG. 3A-3D are schematic diagrams of an online discussing interface according to one embodiment of the present disclosure.

FIG. 4 is a flowchart of an online discussing method with compiling program function according to one embodiment of the present disclosure.

FIG. 5 is a block diagram of an online discussing system with compiling program function according to one embodiment of the present disclosure.

FIG. 6 is a schematic diagram of an online discussing interface according to one embodiment of the present disclosure.

FIG. 7 is a schematic diagram of an online discussing interface according to one embodiment of the present disclosure.

### DETAILED DESCRIPTION

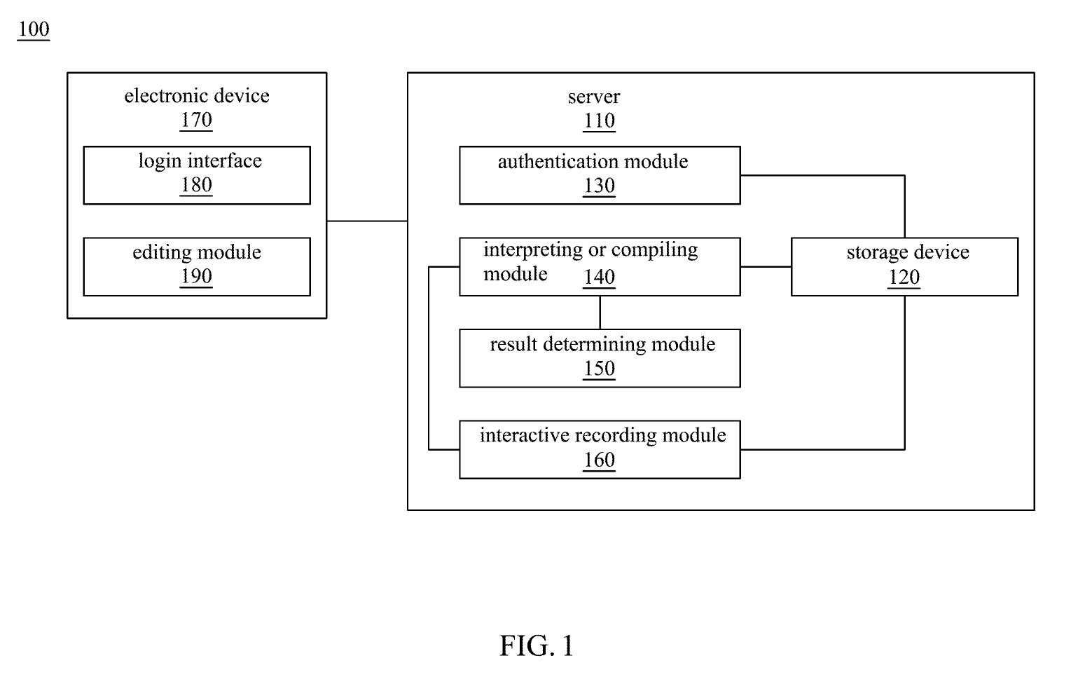

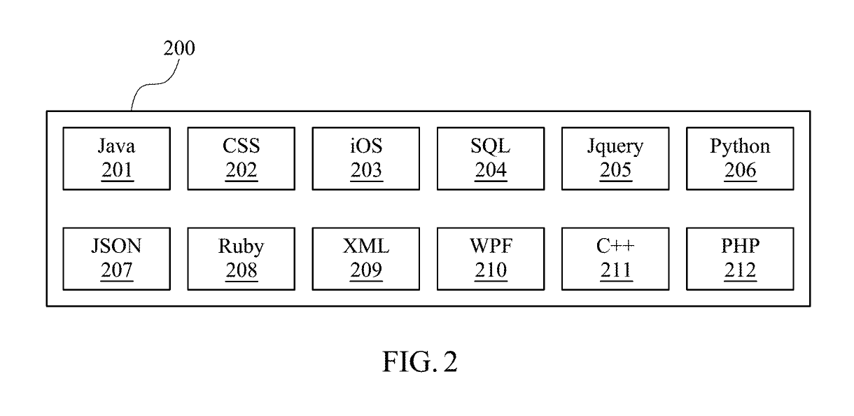

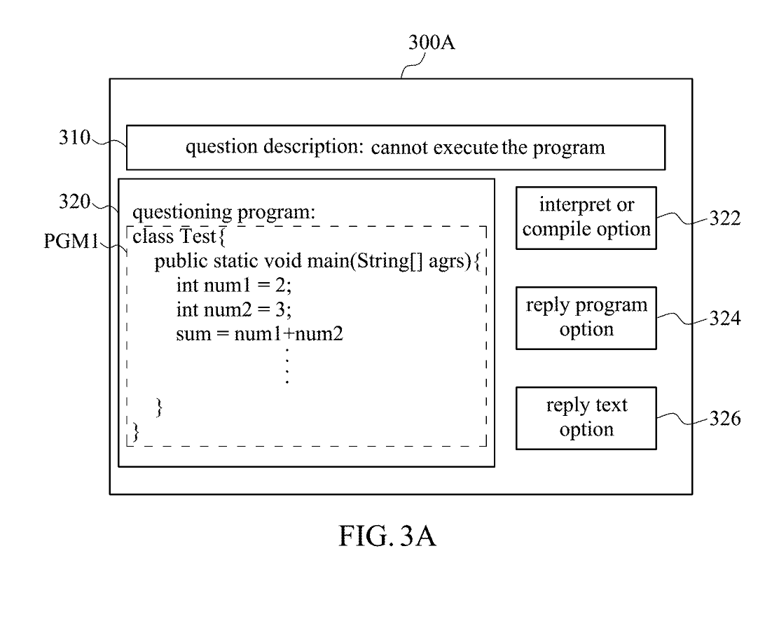

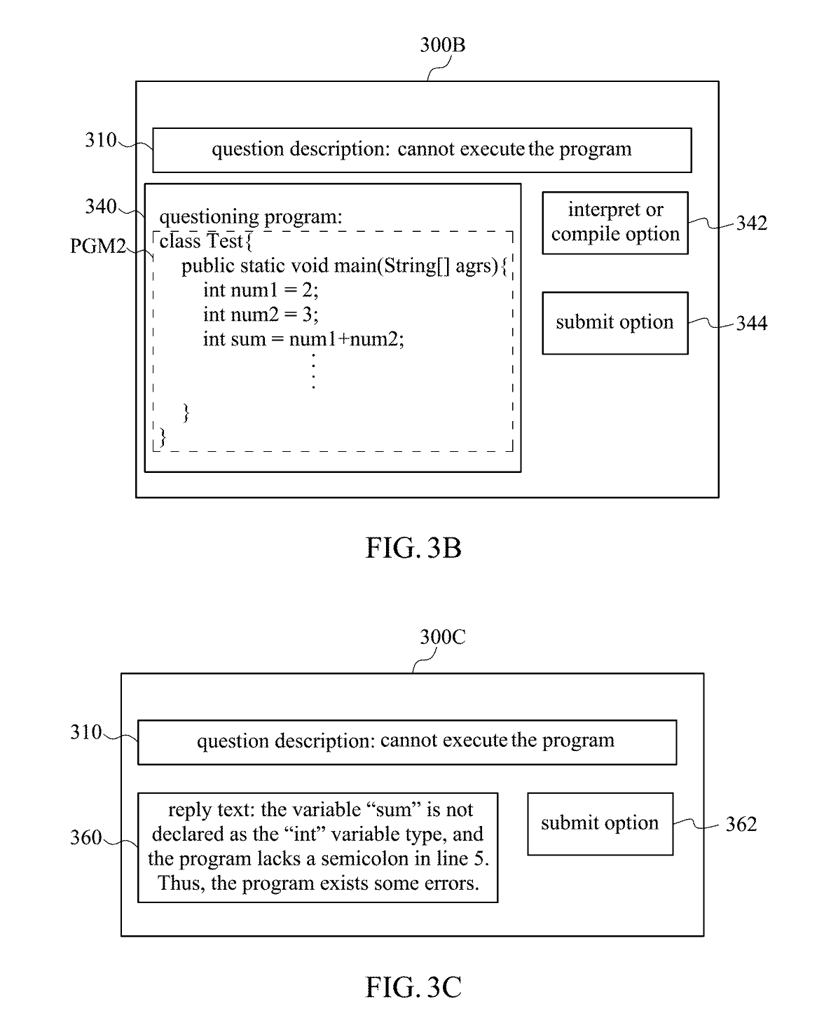

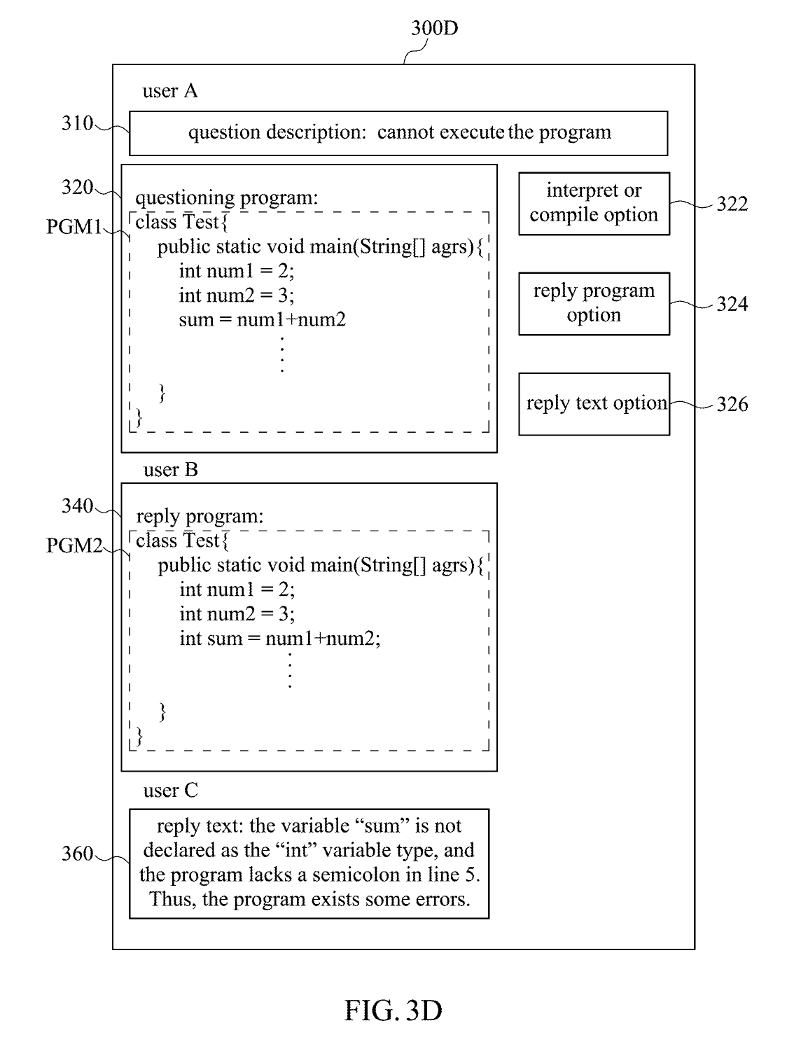

Reference is made to FIGS. 1, 2, and 3A-3D. FIG. 1 is a block diagram of an online discussing system 100 with compiling program function according to one embodiment of the present disclosure. FIG. 2 is a schematic of a programming language selection interface according to one embodiment of the present disclosure. FIG. 3A-3D are schematic diagrams of an online discussing interface according to one embodiment of the present disclosure.

The online discussing system 100 with compiling program function includes a server 110. The server 110 includes a storage device 120, an authentication module 130, an interpreting or compiling module 140, a result determining module 150, and an interactive recording module 160. The authentication module 130 receives and verifies a user information from an electronic device 170. After verifying the user information, the authentication module 130 transmits a programming language selection interface 200 and an online discussing interface (for example, the online discussing interface 300B) to the electronic device 170. The interpreting or compiling module 140 receives a programming language selection signal inputted from the programming language selection interface 200, and selectively receives a reply program PGM2 received from the online discussing interface (for example, the online discussing interface 300B). When the interpreting or compiling module 140 receives the reply program PGM2, the interpreting or compiling module 140 determines interpreting or compiling the reply program PGM2 according to the programming language selection signal. The result determining module 150 executes the reply program PGM2 and outputting an execution result to the interpreting or compiling module 140. The interactive recording module 160 records the reply program PGM2 and the execution result, and enabling to display the reply program PGM2 and the execution result on the online discussing interface (for example, the online discussing interface 300D).

As shown in FIG. 1, the storage device 120 of the server 110 can be implemented by a read only memory (ROM), a flash memory, a floppy disk drives, a hard disk drives (HDD), a optical storage, a USB drive, a magnetic tap, a database accessed by internet, or a storage medium etc., which is configured to store information. The authentication module 130, the interpreting or compiling module 140, the result determining module 150, and the interactive recording module 160 in the server 110 can be implemented respectively or along with each other, and these modules can be implemented by a micro controller, a microprocessor, a digital signal processor, an application specific integrated circuit (ASIC), a firmware, a program, or a logical circuitry. In one embodiment, the server 110 can include a first processor (not shown). The first processor is coupled to the storage device 120 and configured to execute a plurality of modules including an authentication module 130, an interpreting or compiling module 140, a result determining module 150 and an interactive recording module 160. The electronic device 170 can be any kinds of electronic devices, e.g. a personal computer, a smart phone, a panel device, or a smart TV, etc. In one embodiment, the electronic device 170 can include a second processor (not shown). The second processor is configured to execute the editing module 190 and generate the login interface 180. The server 110 can communicate with the electronic device 170 by wire or wireless network. In one embodiment, the server 110 connects to the multiple electronic devices 170 by wire or wireless network and provides services to the electronic devices 170. For example, the server 110 receives the inputted information from both the smart phone and pan& device according to an order, or the server 110 receives the inputted information from both the smart phone and panel device in the same time.

Therefore, the online discussing system 100 with compiling program function can provide user to compile or interpret the programs online and also provide the detecting problem function for the programs. This can make replier clearly understand the question raised by the questioner, and the replier can reply it by editing a reply program and then providing the reply program to answer the question.

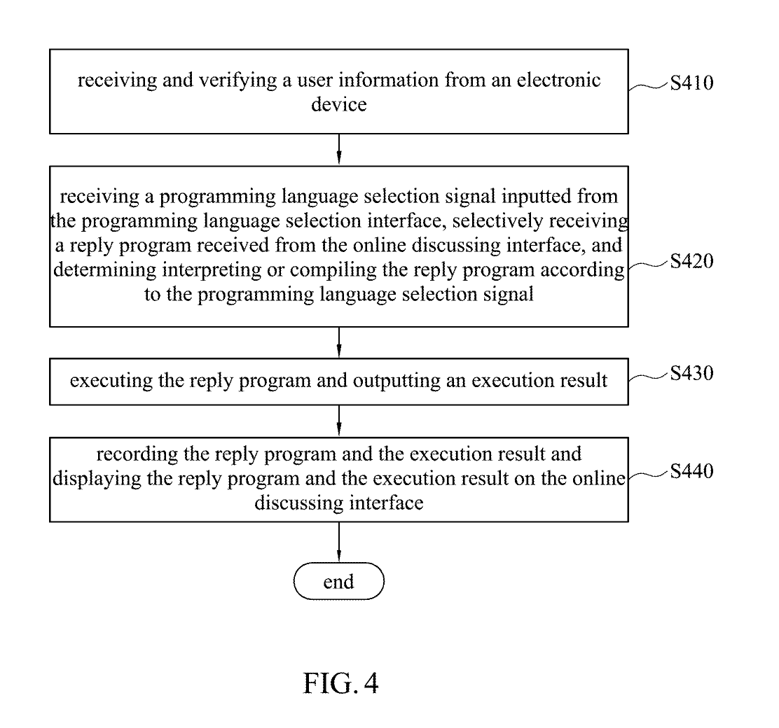

The online discussing system 100 with compiling program function method is further described in the following paragraphs. Refer to FIGS. 1 and 4, FIG. 4 is a flowchart of an online discussing method with compiling program function according to one embodiment of the present disclosure. To be convenient for explanation, the operation of the online discussing system 100 will be described together with the online discussing method.

In step S410, the authentication module 130 receives and verifies a user information from an electronic device 170. After verifying the user information, the authentication module 130 transmits a programming language selection interface 200 and an online discussing interface (for example, the online discussing interface 300B) to the electronic device 170.

In one embodiment, the electronic device 170 includes a login interface 180 for receiving the user information. The user information includes an account, a password or other information for identifying the user. When user inputs the user information into the login interface 180, the electronic device 170 transmits the user information to the authentication module 130 of the server 110.

Next, the authentication module 130 receives and verifies the user information. After successfully verifying the user information, the authentication module 130 transmits the programming language selection interface 200 and the online discussing interface (for example, the online discussing interface 300B) to the electronic device 170. In one embodiment, the programming language selection interface 200 and the online discussing interface (for example, the online discussing interface 300B) can be respectfully shown on the different web pages or the different interfaces corresponding to different applications. In one embodiment, the programming language selection interface 200 and the online discussing interface (for example, the online discussing interface 300B) both can be shown on the same web page or the same interface of one application.

In one embodiment, the online discussing interface can be the online discussing interface 300A for raising the question, the online discussing interface 300B for answering (or replying) the question by a program, the online discussing interface 300C for answering (or replying) the question by text, or the online discussing interface 300D comprising the questioning program PMG1, the reply program PMG2 and the reply text (e.g. the content of the text column 360). However, it is to be understood that the content of the online discussing interface 300A-300D is determined by the content replied by the user. The content of the online discussing interface 300A-300D should not be limited by these examples.

In another embodiment, if the authentication module 130 does not successfully verify the user information, the authentication module 130 transmits a failure login information to the electronic device 170.

In step S420, the interpreting or compiling module 140 is configured to receive a programming language selection signal inputted from the programming language selection interface 200, and selectively receiving a reply program PGM2 received from the online discussing interface 300B. When the interpreting or compiling module 140 receives the reply program PGM2, the interpreting or compiling module 140 determines interpreting or compiling the reply program PGM2 according to the programming language selection signal.

In one embodiment, when the electronic device 170 receives the programming language selection interface 200, the user can see the programming language selection interface 200 displayed on the display (not shown) of the electronic device 170. As shown in FIG. 2, the programming language selection interface 200 includes multiple programming language options 201-212. For example, but not limited thereto, the programming language selection interface 200 includes Java programming language option 201, CSS programming language option 202, iOS programming language option 203, SQL programming language option 204, Jquery programming language option 205, Python programming language option 206, JSON programming language option 207, Ruby programming language option 208, XML programming language option 209, WPF programming language option 210, C++ programming language option 211, and PHP programming language option 212. By selecting one of the programming language options 201-212, the user can determine a programming language for replying or raising a question. The selected programming language option (e.g. Java programming language option 201) corresponds to a programming language selection signal (e.g. Java programming language selection signal). In addition, the electronic device 170 transmits the programming language selection signal to the server 110. Next, the interpreting or compiling module 140 receives the programming language selection signal.

In one embodiment, the server 110 presents the online discussing interface 300A according to the programming language selection signal. For example, when the server 110 receives a programming language selection signal and this programming language selection signal corresponds to the Java programming language, the server 110 transmits the online discussing interface 300A related to the Java programming questions to the electronic device 170. When user wants to answer a question shown on the online discussing interface 300A, the user can select a way for answering the question by the online discussing interface 300A.

In another embodiment, the server 110 transmits the online discussing interface 300A to the electronic device 170. In this embodiment, the online discussing interface 300A includes multiple questions of different kinds programming languages. The replier can use the specific programming language corresponded to the programming language selection signal to reply the question raised by the questioner. For example, the replier can select C++ programming language option 211 to edit a C++ program for answering the question raised by the questioner.

It should be noted that the programming languages could be classified as compiled language and interpreted language. The compiled language, such as C or C++, needs to compile the source program code into the object code and then transfer the object code to the binary code by a linker for executing. On the other hand, the interpreted language, such as Python, Ruby or PHP, which is step-by-step to directly translate and execute the source code without pre-runtime translation. Besides, some programming language needs to be implemented by both compile and interpreter solutions. For example, Java programming language needs to process the compiling procedure firstly to generate the machine code from the source code and then process the interpreting procedure to execute the machine code. The machine code can be binary code, and the machine code is independent of the platform. By selecting one of the programming language options 201-212 through the programming language selection interface 200, the interpreting or compiling module 140 can receive the programming language selection signal corresponds to the selected programming language option. Thus, the interpreting or compiling module 140 can determine to interpret (e.g. Python programming languages), compile (e.g. C++ programming languages), or compile and then interpret (e.g. Java programming languages) the received program according to the programming language selection signal.

For example, after the sever 110 receives the reply program PMG2 in FIG. 3B, the interpreting or compiling module 140 determines to interpret or compile the questioning program PMG2 according to the programming language selection signal. For example, if the programming language selection signal presents the user adopts C++ programming language to edit the reply program PMG2, the interpreting or compiling module 140 compiles the reply program PMG2. In another example, if the programming language selection signal presents the user adopts Python programming language to edit the reply program PMG2, the interpreting or compiling module 140 interprets the reply program PMG2.

In one embodiment, the questioner can raise a question by the online discussing interface 300A. The online discussing interface 300A includes a question description column 310 and a questioning program column 320. In another embodiment, the online discussing interface 300A further includes at least one option of an interpret or compile option 322, a reply program option 324 and a reply text option 326. In one embodiment, these options can be implemented as buttons or icons. Through the online discussing interface 300A, the questioner can input the descriptions related to the programming questions into the question description column 310 and input the questioning program PMG1 into the questioning program column 320.

In one embodiment, the replier can online interpret or compile the questioning program PMG1 through the online discussing interface 300A to immediately realize the problem of the questioning program PMG1. For example, when the replier sees question description column 310 and the questioning program column 320 of the online discussing interface 300A, the replier can select the interpret or compile option 322 for transmitting the questioning program PMG1 to the server 110. And, the interpreting or compiling module 140 determines to interpret or compile the questioning program PMG1 according to the programming language selection signal. In this way, the online discussing system 100 can achieve the effect of directly online compiling or interpreting the program.

For example, when the programming language selection signal corresponds to Ruby programming language, the interpreting or compiling module 140 interprets the questioning program PMG1. For another example, when the programming language selection signal corresponds to C++ programming language, the interpreting or compiling module 140 compiles the questioning program PMG1.

Next, the interpreting or compiling module 140 enables to display the execution result of the questioning program PMG1 on the online discussing interface 300A. For instance, the interpreting or compiling module 140 directly enables to display the execution result of the questioning program PMG1 on the questioning program column 320 of the online discussing interface 300A.

In one embodiment, the replier can edit a reply program PMG2 through the online discussing interface 300A to directly provide the correct solution of the program to the questioner. For example, the replier can select the reply program option 324 in FIG. 3A to edit the reply program PMG2 and then transmit the reply program PMG2 to the interpreting or compiling module 140 of the server 110 after the reply program PMG2 is done editing.

In one embodiment, when the reply program option 324 is selected, the editing module 190 of the electronic device 170 opens a program editing interface by a new window to provide the replier editing the reply program PMG2. In another embodiment, the server 110 is further used for transmitting the program editing interface to the electronic device 170 to provide the replier editing the reply program PMG2. And, the electronic device 170 displays the program editing interface by a display (not shown).

In one embodiment, the program editing interface can be a reply program column 340 of the online discussing interface 300B for editing the reply program PMG2 as shown in FIG. 3B. Then, the editing module 190 transmits the reply program PMG2 to the interpreting or compiling module 140 of the server 110 after the reply program PMG2 is done editing. However, the person skilled in art should understand that the program editing interface is not limited to the examples above mentioned.

After the replier finishes editing the reply program PMG2, the editing module 190 of the electronic device 170 transmits the reply program PMG2 to the interpreting or compiling module 140 of the server 110, and the step S430 is performed.

In one embodiment, after the replier finishes editing the reply program PMG2 as shown in FIG. 3B, the replier selects an interpret or compile option 342 to enable the editing module 190 transmitting the reply program PMG2 to the interpreting or compiling module 140 of the server 110. When the interpreting or compiling module 140 receives the reply program PMG2, the interpreting or compiling module 140 determines to interpret or compile the reply program PMG2 according to the programming language selection signal.

Besides, in one embodiment, when the submit option 344 of the online discussing interface 300B is selected, the reply program PMG2 is transmitted to the interactive recording module 160 of the server 110.

In another embodiment, the replier can select the reply text option 326 as shown in FIG. 3A to reply the question by text. When the reply text option 326 is selected, the editing module 190 of the electronic device 170 opens a text editing interface for editing a text editing file. And, the editing module 190 transmits the text editing file to the interactive recording module 160 after the text editing file is done editing. The text editing interface can be the text column 360 of the online discussing interface 300C for editing the text editing file. After the user select the submit option 362, the editing module 190 transmits the text editing file which is finished editing to the interactive recording module 160.

In one embodiment, the electronic device 170 opens a text editing interface by a new window to provide the replier editing the text editing file. However, the person skilled in art should understand that the text editing interface is not limited to the examples above mentioned.

In another embodiment, no matter the replier selects using text or program to replay the question, the editing module 190 of the electronic device 170 can transmit the text editing file or the reply program PMG2 edited by the replier to the interactive recording module 160 of the server 110. In addition, the text editing file or the reply program PMG2 can be displayed on the online discussing interface 300D. As such, the replier and the questioner both can see the all the content post by each other. In one embodiment, other user also can reply the content post by the user B or user C through the online discussing interface 300D. Also, other user can reply the content by text or program. The reply method is the same as aforementioned embodiment, and detailed descriptions thereof will be omitted.

In step S430, the result determining module 150 is configured to execute the reply program PMG2 and outputting an execution result to the interpreting or compiling module 140.

In one embodiment, when the replier finishes editing the reply program PMG2, the replier selects the interpret or compile option 342 to transmit the reply program PMG2 to the interpreting or compiling module 140. Next, the interpreting or compiling module 140 determines to interpret or compile the reply program PMG2 and then transmits the interpreted or compiled reply program PMG2 to the result determining module 150.

After the result determining module 150 executing the reply program PMG2, the result determining module 150 transmits the execution result to the interpreting or compiling module 140.

It should be noted that the result determining module 150 can be used for implementing a simulation testing environment when developing the program. For instance, a specific area of the memory can be separated as an isolated memory space when executing a program. The program is limited to execute only by this specific area of the memory. The program cannot arbitrary access the other local resource. In this way, the result determining module 150 can help to avoid the damage which is caused by arbitrary accessing the local resource.

In step S440, the interactive recording module 160 is configured to record the reply program PMG2 and the execution result and enabling to display the reply program PGM2 and the execution result on the online discussing interface (e.g. the execution result can be displayed on the reply program column 340 of the online discussing interface 300B).

In one embodiment, when the interactive recording module 160 receives the text editing file, the interactive recording module 160 records the text editing file and enables to display the text editing file on the online discussing interface (e.g. the execution result can be displayed on the text column 360 of the online discussing interface 300C).

In one embodiment, the interactive recording module 160 enables to display the text editing file, the reply program PMG2 and/or the execution result of the reply program PMG2 received by the server 110 on the online discussing interface 300D. In one embodiment, the online discussing interface 300D includes a question description column 310, a questioning program column 320, a reply program column 340, and a text column 360. The content of the question description column 310 and the questioning program column 320 is written by user A, the content of the reply program column 340 is written by user B, and the content of the text column 360 is written by user C.

Thus, the different users can login the online discussing system 100 and then immediately compile a program, interpret a program, or edit a file on the same platform. This solves the problem of the inconsistent programming environments between the replier and the questioner. The technology features also overcome the limitation of installation environments corresponded to the different programming languages.

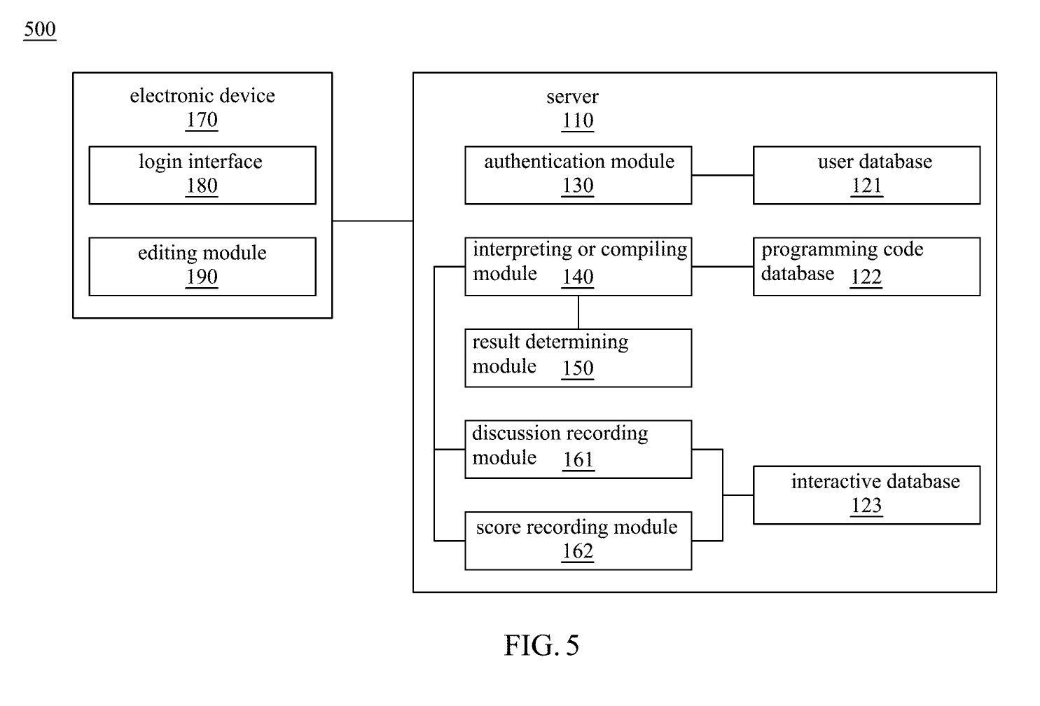

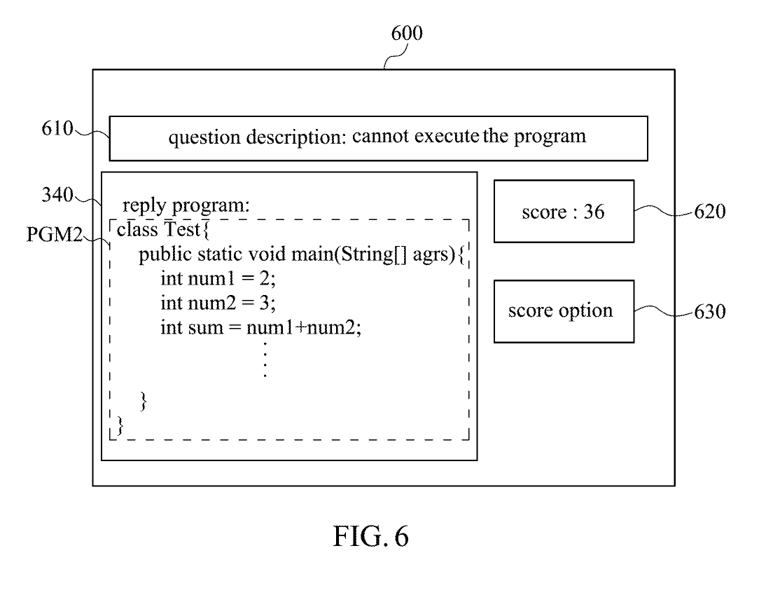

Next, refer to FIGS. 5 and 6, FIG. 5 is a block diagram of an online discussing system 500 with compiling program function according to one embodiment of the present disclosure. FIG. 6 is a schematic diagram of an online discussing interface 600 according to one embodiment of the present disclosure. The difference between FIG. 5 and FIG. 1 is that the online discussing system 500 of FIG. 5 further includes a discussion recording module 161, a score recording module 162, a user database 121, a programming code database 122, and an interactive database 123.

In one embodiment, the discussion recording module 161 and the score recording module 162 can be included in the interactive recording module 160. The discussion recording module 161 and the score recording module 162 can be implemented respectively or along with each other, and these module can be implemented by a micro controller, a microprocessor, a digital signal processor, an application specific integrated circuit (ASIC), a firmware, a program, or a logical circuitry. In one embodiment, the server 110 can include a first processor (not shown). The first processor is configured to execute the discussion recording module 161 and the score recording module 162. In one embodiment, the user database 121, the programming code database 122, and the interactive database 123 can be stored respectively in different storage devices. Besides, the elements (or modules) in FIG. 5 and FIG. 6 corresponding to the same notations are the same elements (or modules). The question description column 610 in FIG. 6 is the same as the question description column 310 in FIG. 3B, and the reply program column 640 in FIG. 6 is the same as the reply program column 340 in FIG. 3B. As such, the detailed descriptions thereof will be omitted.

The discussion recording module 161 is configured to record all the reply program PMG2, the questioning program PMG1, and/or the text editing file displayed online discussing interface 600. And, the reply program PMG2, the questioning program PMG1, and/or the text editing file are inputted by the electronic device 170. In one embodiment, the discussion recording module 161 is configured to record all the messages inputted from the multiple electronic devices 170 and transmitting the messages into the interactive database 123.

The score recording module 162 is configured to receive a score message from the online discussing interface 600, and the score message is inputted by the electronic device 170. In one embodiment, the questioner or the replier can select the score option 630 through the online discussing interface 600 to give a score corresponding to the reply program PMG2 or the content of the reply text. For instance, any user can input a value, and the score recording module 162 adds the value to a current accumulated value and then comes up with a score. The score is displayed in a score column 620 (e.g. the score is 36). In another embodiment, the replier can also use the same way to give a score corresponding to a question. As such, the detailed descriptions thereof will be omitted.

As such, users can learn that the question or the reply content is accepted or not accepted for most users according to the score column 620.

On the other hand, in this embodiment, the user database 121 stores the user information. When the authentication module 130 receives the user information from electronic device 170, the authentication module 130 compares the received user information to the known-user information stored in the user database 121 and verifies whether the user corresponding to the received user information is a known-user. If the user is a known-user, the authentication module 130 permits the electronic device 170 to finish the login operation. If the user is an unknown-user, the authentication module 130 transmits a failure login information to the electronic device 170.

Besides, the programming code database 122 stores the reply program PMG2 and a questioning program PMG1. When the interpreting or compiling module 140 receives the reply program PMG2 and/or the questioning problem PMG1, the interpreting or compiling module 140 stores the reply program PMG2 and/or the questioning problem PMG1 into the programming code database 122. Besides, the interactive database 123 stores the execution result and a text editing file. In one embodiment, the interactive database 123 stores all the data inputted from the at least one electronic device 170 to record every interactive data displayed on online discussing interface 600.

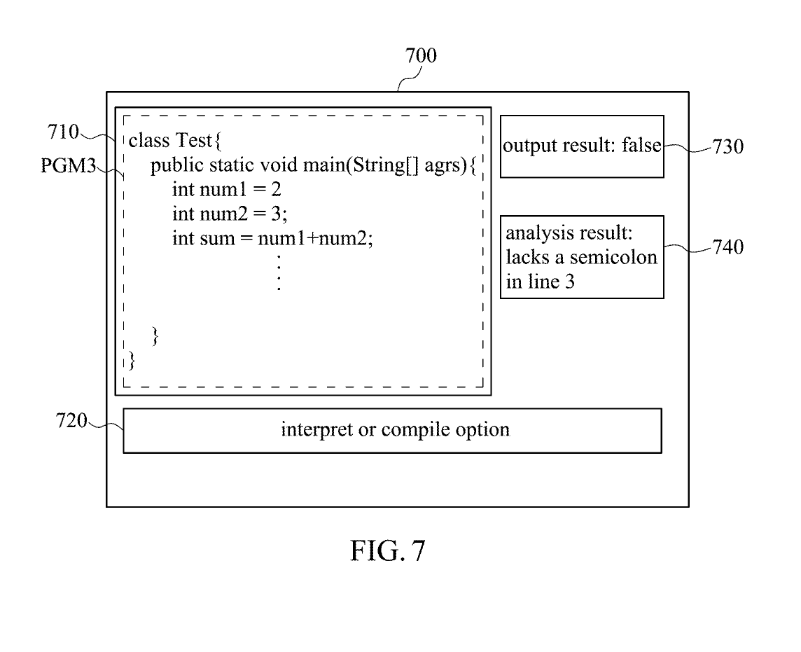

Next, please refer to FIG. 7, FIG. 7 is a schematic diagram of an online discussing interface 700 according to one embodiment of the present disclosure. In one embodiment, the electronic device 170 is further used for inputting the questioning program PMG3 to the online discussing interface 700. The online discussing interface 700 can be implemented as a web page.

In one embodiment, the online discussing interface 700 includes a questioning program column 710, an interpret or compile option 720, an output result column 730, and analysis result column 740. When the interpret or compile option 720 is selected, the interpreting or compiling module 140 of the server 110 determines interpreting or compiling the questioning program PMG3 according to the programming language selection signal. The result determining module 150 outputs execution results on the output result column 730 of the online discussing interface 700. And, an analysis result of the questioning program PMG3 is displayed on the analysis result 740.

Besides, in this embodiment, the interpreting or compiling module 140 is further used for receiving the execution result from the result determining module 150 and enabling to display the execution result, an error message, a semantic analysis of the questioning program PMG3 on the online discussing interface 700.

In one embodiment, when the interpreting or compiling module 140 cannot successfully compile or interpret the questioning program PMG3, an error message “false” is outputted on the output result column 730 to indicate the semantic failure. And, a description is displayed on the analysis result column 740 for explaining why the questioning program PMG3 cannot be successfully compiled or interpreted. For example, but not limited thereto, the analysis result column 740 can use for displaying the notification when the program lacks a semicolon, the program includes the incorrect case, the program includes the incorrect accessing privilege of variable, or the class name is inconsistent with the file name of the program. Therefore, the analysis result column 740 can use for providing some error messages for suggesting the questioner to correct the questioning program PMG3.

In another embodiment, after the interpreting or compiling module 140 successfully compiling or interpreting the questioning program PMG3, the result determining module 150 executes the questioning program PMG3. If the execution result (e.g. the execution result is 4) generated by the result determining module 150 is different from the expected result (e.g. the expected result is 5), the interpreting or compiling module 140 outputs the execution result on the output result column 730. And, an error message is displayed on the output result column 730 to describe the execution result is wrong (or different from the expected result). The questioner can realize that there is no semantic error in the questioning program PMG3, but the execution result different from the expected result. That is, the compiling or interpreting step does not cause error, but the execution result is not correct. Thus, the questioner can conclude that maybe a parameter of the variable is incorrect (or a typographical error) in the questioning program PMG3. For example, a parameter should be 3 in the questioning program PMG3. But, the questioner writes the questioning program PMG3 with the wrong parameter, such as 2 (which is a typographical error). For another example, an incorrect function is called in questioning program PMG3 due to a typographical error. These conditions could cause the execution result inconsistent with the expected result. And, the questioner can correct the questioning program PMG3 according to the messages provided on the analysis result column 740.

Through utilizing at least one embodiment described above, the disclosure provides the programmer a discussing platform for directly online compiling or interpreting the programs and then detecting the problems of the programs. The online discussing system with compiling program function solves the problem of the inconsistent programming environments between the replier and the questioner. The disclosure overcomes the limitation of installation environments corresponded to the different programming languages.

Although the present disclosure has been described in considerable detail with reference to certain embodiments thereof, other embodiments are possible. Therefore, the scope of the appended claims should not be limited to the description of the embodiments contained herein.

What is claimed is:

1. An online discussing system, comprising:
a server, comprising:
a storage device; and
a first processor coupled to the storage device and configured to execute a plurality of modules including an authentication module, an interpreting or compiling module, a result determining module and an interactive recording module;
wherein the authentication module is configured to receive and verify a user information from an electronic device; after verifying the user information, the authentication module transmits a programming language selection interface and an online discussing interface to the electronic device;
the interpreting or compiling module is configured to receive a programming language selection signal inputted from the programming language selection interface, and selectively receive a reply program received from the online discussing interface; wherein, when the interpreting or compiling module receives the reply program, the interpreting or compiling module determines interpreting or compiling the reply program according to the programming language selection signal;
the result determining module is configured to execute the reply program and output an execution result to the interpreting or compiling module; and
the interactive recording module is configured to record the reply program and the execution result, and configured to display the reply program and the execution result on the online discussing interface.

2. The online discussing system of claim 1, further comprising:
wherein the online discussing interface comprises an interpreting or compiling option, a reply program option, or a reply text option.

3. The online discussing system of claim 2, wherein the electronic device comprising:
a second processor configured to execute an editing module and generate a login interface;
wherein the login interface is configured to receive the user information; and
the editing module is configured to open a text editing interface for editing a text editing file when the reply text option is selected, and transmit the text editing file to the interactive recording module after the text editing file is done editing.

4. The online discussing system of claim 2, wherein the electronic device comprising:
a second processor configured to execute an editing module and generate a login interface;
wherein the login interface is configured to receive the user information; and
the editing module is configured to open a program editing interface for editing the reply program, and transmit the reply program to the interpreting or compiling module of the server after the reply program is done editing.

5. The online discussing system of claim 2, wherein the electronic device is configured to input a questioning program to the online discussing interface; when the an interpreting or compiling option is selected, the interpreting or compiling module of the server determines to interpret or compile the questioning program of the online discussing interface and enables to display an analysis result of the questioning program on the online discussing interface.

6. The online discussing system of claim 1, wherein the interactive recording module is configured to receive a text editing file from the online discussing interface; when the interactive recording module receives the text editing file, the interactive recording module records the text editing file and displays the text editing file on the online discussing interface.

7. The online discussing system of claim 1, wherein the programming language selection interface comprises a plurality of programming language options.

8. The online discussing system of claim 1, wherein the interactive recording module further comprises:
a discussion recording module is configured to record the reply program, a questioning program, or a text editing file inputted by the electronic device; and
a score recording module is configured to receive a score message from the online discussing interface, and the score message is inputted by the electronic device.

9. The online discussing system of claim 1, wherein the interpreting or compiling module is configured to receive the execution result from the result determining module and displaying the execution result, an error message, and a semantic analysis on the online discussing interface.

10. The online discussing system of claim 1, wherein the storage device further comprising:
a user database is configured to store the user information;
a programming code database is configured to store the reply program and a questioning program; and
an interactive database is configured to store the execution result and a text editing file.

11. A method, comprising:
receiving and verifying a user information from an electronic device by a server, and transmitting an online discussing interface to the electronic device after verifying the user information;
receiving a programming language selection signal inputted from the programming language selection interface;
providing a programming language selection interface to the electronic device;
selectively receiving a reply program received from the online discussing interface; wherein, when the server receives the reply program, the server determines interpreting or compiling the reply program according to the programming language selection signal;
executing the reply program and outputting an execution result; and
recording the reply program and the execution result, and displaying the reply program and the execution result on the online discussing interface.

12. The method of claim 11, further comprising:
wherein the online discussing interface comprising an interpreting or compiling option, a reply program option, or a reply text option.

13. The method of claim 12, further comprising:
receiving the user information by a login interface; and
opening a text editing interface by an editing module for editing when the reply text option is selected, and transmitting the text editing file to the interactive recording module after the text editing file is done editing.

14. The method of claim 12, further comprising:
receiving the user information by a login interface; and
opening a program editing interface by an editing module for editing the reply program, and transmitting the reply program to the interpreting or compiling module of the server after the reply program is done editing.

15. The method of claim 12, wherein a questioning program is inputted to the online discussing interface by the electronic device; when the an interpreting or compiling option is selected, the server determines to interpret or compile the questioning program of the online discussing interface and enables to display an analysis result of the questioning program on the online discussing interface.

16. The method of claim 11, further comprising:
receiving a text editing file from the online discussing interface; when the server receives the text editing file, the server records the text editing file and displays the text editing file on the online discussing interface.

17. The method of claim 11, wherein the programming language selection interface comprises a plurality of programming language options.

18. The method of claim 11, further comprising:
recording the reply program, a questioning program, or a text editing file inputted by the electronic device; and
receiving a score message from the online discussing interface, and the score message is inputted by the electronic device.

19. The method of claim 11, further comprising:
displaying the execution result, an error message, and a semantic analysis on the online discussing interface.

20. The method of claim 11, further comprising:
storing the user information;
storing the reply program and a questioning program; and
storing the execution result and a text editing file.
